(19) United States
(12) Patent Application Publication
(10) Pub. No.: US 2016/0265981 A1
(43) Pub. Date: Sep. 15, 2016

(54) CIRCUITS FOR TEMPERATURE MONITORING

(71) Applicant: The Trustees of Columbia University in the City of New York, New York, NY (US)

(72) Inventors: Mingoo Seok, New York, NY (US); Peter R. Kinget, Summit, NJ (US); Teng Yang, New York, NY (US); Seongjong Kim, New York, NY (US)

(21) Appl. No.: 15/033,858

(22) PCT Filed: Nov. 3, 2014
(86) PCT No.: PCT/US14/63723

§ 371 Date: May 2, 2016

Related U.S. Application Data
(60) Provisional application No. 61/899,275, filed on Nov. 3, 2013.

(51) Int. Cl. G01K 7/01

(52) U.S. Cl. CPC G01K 7/01

(57) ABSTRACT

Circuits for temperature monitoring are provided having a first voltage output and a second voltage output comprising: a first transistor having a first transistor input, a first transistor output, and a first transistor control, wherein the first transistor input is connected to a supply voltage; a first diode having a first diode input and a first diode output, wherein the first diode output is connected to ground and the first diode input is connected to the first transistor output, the first transistor control and the first voltage output; a second transistor having a second transistor input, a second transistor output, and a second transistor control, wherein the second transistor input is connected to a supply voltage; a second diode having a second diode input and a second diode output, wherein the second diode input is connected to the second transistor output, the second transistor control, and the second voltage output.

### CROSS REFERENCE TO RELATED APPLICATION

This application claims the benefit of U.S. Provisional Patent Application No. 61/899,275, filed Nov. 3, 2013, which is hereby incorporated by reference herein in its entirety.

### TECHNICAL FIELD

The disclosed subject matter relates to circuits for temperature monitoring.

### BACKGROUND

The use of circuits for temperature monitoring that can be placed directly on a chip, such as a microprocessor, for thermal management is increasing in popularity due to the need of managing the operation of such chips based on local and global thermal constraints. The technological advancements relating to multi-core architectures, tri-gate devices and low-voltage operation have created new requirements for the use of circuits for temperature monitoring.

Accordingly, new circuits for temperature monitoring are desirable.

### SUMMARY

Circuits for temperature monitoring are provided. In some embodiments, a circuit for temperature monitoring, having a first voltage output and a second voltage output, comprising: a first transistor having a first transistor input, a first transistor output, and a first transistor control, wherein the first transistor input is connected to a supply voltage; a first diode having a first diode input and a first diode output, wherein the first diode output is connected to ground and the first diode input is connected to the first transistor output, the first transistor control and the first voltage output; a second transistor having a second transistor input, a second transistor output, and a second transistor control, wherein the second transistor input is connected to a supply voltage; and a second diode having a second diode input and a second diode output, wherein the second diode input is connected to the second transistor output, the second transistor control, and the second voltage output.

In some embodiments, a circuit for temperature monitoring, having a first bias input, first voltage output, a second voltage output, comprising: a first transistor having a first transistor input, a first transistor output, and a first transistor control, wherein the first transistor input is connected to a supply voltage and the first transistor control is connected to the first bias input; a second transistor having a second transistor input, a second transistor output, and a second transistor control, wherein the second transistor input is connected to the first transistor output and the second transistor output and the second transistor control are connected to the first voltage output; a first diode having a first diode input and a first diode output, wherein the first diode output is connected to ground, and the first diode input is connected to the second transistor output, the second transistor control, and the first voltage output; a third transistor having a third transistor input, a third transistor output, and a third transistor control, wherein the third transistor input is connected to a supply voltage and the third transistor control is connected to the first bias input; a fourth transistor having a fourth transistor input, a fourth transistor output, and a fourth transistor control, wherein the fourth transistor input is connected to the third transistor output and the fourth transistor output and the fourth transistor control are connected to the second voltage output; and a second diode having a second diode input and a second diode output, wherein the second diode input is connected to the fourth transistor output and the second voltage output.

In some embodiments, A circuit for temperature monitoring, having a first bias input, first voltage output, a second voltage output, comprising: a first transistor having a first transistor input, a first transistor output, and a first transistor control, wherein the first transistor input is connected to a supply voltage and the first transistor control is connected to the first bias input; a second transistor having a second transistor input, a second transistor output, and a second transistor control, wherein the second transistor input is connected to the first transistor output and the second transistor output and the second transistor control are connected to the first voltage output; a first diode having a first diode input and a first diode output, wherein the first diode output is connected to ground, and the first diode input is connected to the second transistor output, the second transistor control, and the first voltage output; a third transistor having a third transistor input, a third transistor output, and a third transistor control, wherein the third transistor input is connected to a supply voltage and the third transistor control is connected to the first bias input; a fourth transistor having a fourth transistor input, a fourth transistor output, and a fourth transistor control, wherein the fourth transistor input is connected to the third transistor output and the fourth transistor output and the fourth transistor control are connected to the second voltage output and the first transistor output; and a second diode having a second diode input, and a second diode output, wherein the second diode input is connected to the fourth transistor output, the fourth transistor control, and the second voltage output;

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is a block diagram showing a portion of a microprocessor in accordance with some embodiments.

FIG. 2 is a circuit diagram showing a reference circuit for temperature monitoring in accordance with some embodiments of the disclosed subject matter.

FIG. 3 is a circuit diagram showing another reference circuit for temperature monitoring in accordance with some embodiments of the disclosed subject matter.

FIG. 4 is a circuit diagram showing another reference circuit for temperature monitoring using a diode connected footer in accordance with some embodiments of the disclosed subject matter.

FIG. 5 is a circuit diagram showing a configuration of a circuit for temperature monitoring using a two-stack diode device in accordance with some embodiments of the disclosed subject matter.

FIG. 6 is a circuit diagram showing an area-balanced configuration of a circuit for temperature monitoring in accordance with some embodiments of the disclosed subject matter.

FIG. 7 is a circuit diagram showing an area-balanced configuration of a circuit for temperature monitoring using a diode connected footer in accordance with some embodiments of the disclosed subject matter.

FIG. 8 is a circuit diagram showing an area-balanced configuration of a circuit for temperature monitoring using a two-stack diode device in accordance with some embodiments of the disclosed subject matter.

FIG. 9 is a circuit diagram showing an additional area-balanced configuration of a circuit for temperature monitoring in accordance with some embodiments of the disclosed subject matter.

### DETAILED DESCRIPTION

Circuits for temperature monitoring are provided. In accordance with some embodiments, the circuits for temperature monitoring can use two transistor voltage reference circuits, though they can also use different configurations of transistor voltage reference circuits in some embodiments. It should be apparent to one of skill in the art that the circuits described herein can be used with different transistor voltage reference circuits based on the constraints that arise from the management of operation of devices (e.g., a microprocessor) with which the circuits are used.

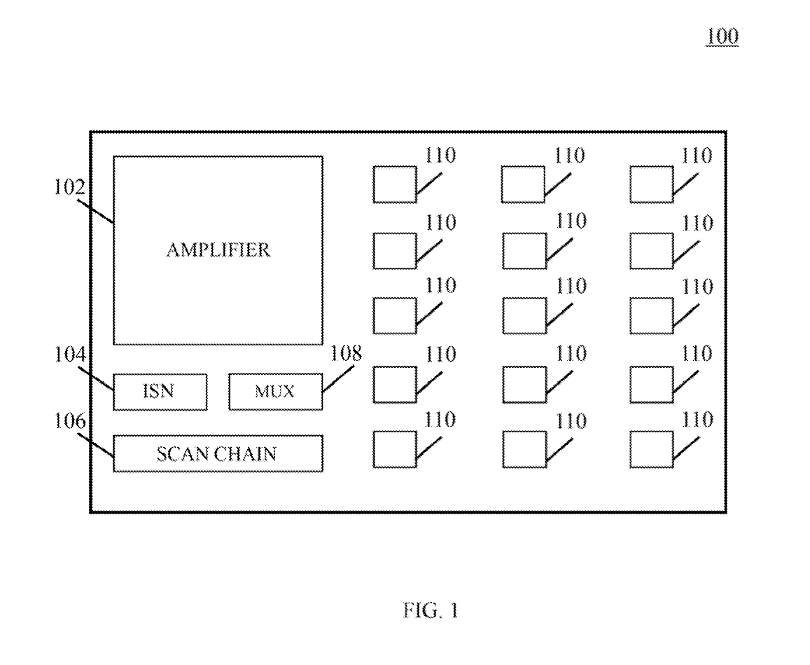

FIG. 1 shows an example 100 of a microprocessor chip that uses circuits for temperature monitoring. As described further below, in accordance with some embodiments, circuits for temperature monitoring 110 can be organized on microprocessor chip 100 and their voltage outputs can be measured and related to temperature changes. For example, as shown in FIG. 1, microprocessor chip 100 includes fifteen circuits for temperature monitoring 110 and scan chain 106 that controls and observes microprocessor 100. The output voltage from each circuit 110 can be transferred off microprocessor chip 100 using a 15-to-1 multiplexer 108, input switch network 104, and on-chip switch capacitor amplifier 102.

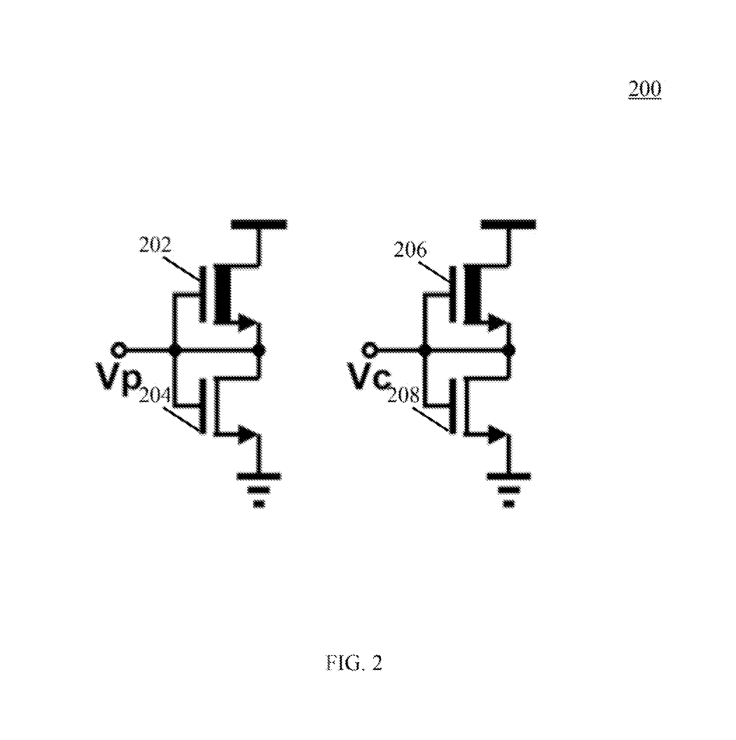

Turning to FIG. 2, an example 200 of a circuit for temperature monitoring in accordance with some embodiments of the disclosed subject matter is shown. As illustrated, circuit 200 includes transistors 202 and 206 and transistors 204 and 208. In some embodiments, transistors 202 and 206 can be native nMOS transistors, pMOS transistors or any other suitable transistors. In some embodiments, transistors 204 and 208 can be high voltage threshold (Vth) nMOS transistors, high voltage threshold (Vth) pMOS transistors or any other suitable transistors. In some embodiments transistors 204 and 208 can be connected to operate as a diode or any suitable diode device.

Each of transistors 202, 204, 206 and 208 can have a drain as an input, a gate as a control and a source as an output such that the voltage between the gate and the source controls the amount of current that flows between the drain and the source of the transistor.

In accordance with some embodiments, as shown in FIG. 2, the drain of transistor 202 is connected to a supply voltage, and the source of transistor 202 is connected to its gate and the drain of transistor 204. The source of transistor 204 is connected to ground and the drain of transistor 204 is connected to its gate. In this configuration, transistor 204 can operate as a diode. As current flows from transistor 202 to transistor 204, an output voltage Vₚ can be measured. Transistors 206 and 208 are similarly connected and operate to provide output voltage V_{c}, which can also be measured.

In some embodiments, sizing each of transistors 202, 204, 206, and 208 can set the temperature coefficient of output voltages Vₚ, V_{c}, either proportional-to-absolute-temperature (PTAT) or complementary-to-absolute-temperature (CTAT). For example, in some embodiments: transistor 202 can be formed of 52 fingers in native nMOS each with a width of 0.6μ, and a length of 0.3μ; transistor 204 can be formed of four fingers in high voltage threshold (Vth) nMOS each with a width of 0.6μ, and a length of 0.3μ; transistor 206 can be formed of twenty fingers in native nMOS each with a width of 0.6μ, and a length of 0.3μ; and transistor 208 can be formed of 76 fingers in high voltage threshold (Vth) nMOS each with a width of 0.6μ, and a length of 0.3μ.

Transistors 202 and 204 and transistors 206 and 208 can operate in a sub-threshold region in accordance with some embodiments. When operating in a sub-threshold region, the flow of current between drain and source for each of transistors 202, 204, 206, and 208 can be represented by:

$${I}_{d} = μ {C}^{′} \frac{W}{L} ( n - 1 ) {ϕ}_{t}^{2} exp ( \frac{{V}_{gs} - {V}_{th}}{n {ϕ}_{t}} ) [ 1 - exp ( - \frac{{V}_{ds}}{{ϕ}_{t}} ) ]$$

where φₜ is thermal voltage, n is the sub-threshold swing, μ is the charge-carrier effective mobility, C′ is the gate oxide capacitance, W is the gate width, L is the gate length, Vₜₕ is the threshold voltage of the device, V_{gs} is the gate-source voltage and V_{ds} is the drain-source voltage.

Drain currents for transistors 202 and 204 are the same and drain currents for transistors 206 and 208 are also the same in accordance with some embodiments of the disclosed subject matter. As a result, output voltages Vₚ and V_{c} can be represented by:

$${V}_{p} = {n}_{204} {ϕ}_{t} ln ( \frac{{μ}_{204}}{{μ}_{202}} \frac{{C}_{204}^{′}}{{C}_{202}^{′}} \frac{{n}_{204} - 1}{{n}_{202} - 1} \frac{{W}_{204} {L}_{202}}{{W}_{202} {L}_{204}} ) - {V}_{th 204} + \frac{{n}_{202}}{{n}_{204}} {V}_{th 202}$$

$${V}_{c} = {n}_{208} {ϕ}_{t} ln ( \frac{{μ}_{208}}{{μ}_{206}} \frac{{C}_{208}^{′}}{{C}_{206}^{′}} \frac{{n}_{208} - 1}{{n}_{206} - 1} \frac{{W}_{208} {L}_{206}}{{W}_{206} {L}_{208}} ) - {V}_{th 208} + \frac{{n}_{206}}{{n}_{208}} {V}_{th 206}$$

In some embodiments, taking the difference between Vₚ and V_{c} can provide a linear expression to temperature (T) as described below:

$${V}_{0} = \frac{{n}_{204} k}{q} ln ( \frac{{W}_{204} {W}_{206} {L}_{202} {L}_{208}}{{W}_{202} {W}_{208} {L}_{204} {L}_{206}} ) T - {b}_{ 204} + {c}_{0} {b}_{ 202}$$

where k is the Boltzmann constant, q is the magnitude of the electrical charge,

$${c}_{0} = \frac{{n}_{204}}{{n}_{202}} , {b}_{204} = {V}_{th 204} - {V}_{th 208} and {b}_{202} = {V}_{th 202} - {V}_{th 206} .$$

Solving for temperature (T) provides:

$$T = {\frac{q}{{n}_{204} k} [ ln ( \frac{{W}_{204} {W}_{206} {L}_{202} {L}_{208}}{{W}_{202} {W}_{208} {L}_{204} {L}_{206}} ) ]}^{- 1} [ {V}_{0} + {b}_{204} - {c}_{0} {b}_{202} ]$$

Thus, based upon a measurement, Vₒ, of the difference between Vₚ and V_{c} using circuit 200, the temperature T, of this circuit can be determined and used to manage operation of a device in which the circuit is located.

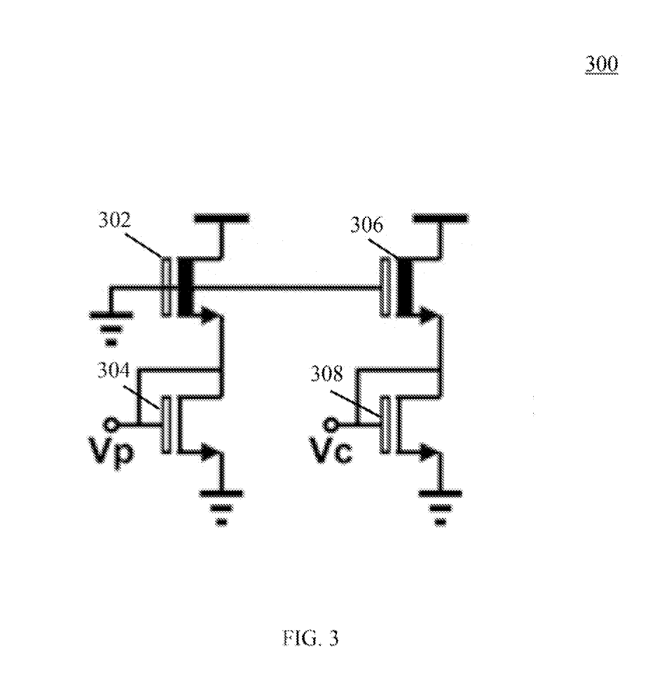

Turning to FIG. 3, another example 300 of a circuit for temperature monitoring in accordance with some embodiments of the disclosed subject matter is shown. As illustrated, circuit 300 includes transistors 302 and 306 and transistors 304 and 308. In some embodiments, transistors 302 and 306 can be native thick oxide nMOS transistors, native thick oxide pMOS transistors or any other suitable transistors. In some embodiments, transistors 304 and 308 can be thick oxide nMOS transistors, thick oxide pMOS transistors or any other suitable transistors. In some embodiments transistors 304 and 308 can be connected to operate as a diode or any suitable diode device.

Each of transistors 302, 304, 306 and 308 can have a drain as an input, a gate as a control and a source as an output such that the voltage between the gate and the source controls the amount of current that flows between the drain and the source of the transistor.

In accordance with some embodiments as shown in FIG. 3, the drain of transistor 302 is connected to a supply voltage, and the source of transistor 302 is connected to the drain of transistor 304. The gate of transistor 302 is connected to the gate of transistor 306 and both of them are connected to ground. The source of transistor 304 is connected to ground and the drain of transistor 304 is connected to its gate. In this configuration, transistor 304 can operate as a diode. As current flows from transistor 302 to transistor 304, an output voltage Vₚ can be measured. Transistors 306 and 308 are similarly connected and operate to provide output voltage V_{c}, which can be measured.

In some embodiments, sizing each of transistors 302, 304, 306, and 308 can set the temperature coefficient of output voltages Vₚ, V_{c}, either proportional-to-absolute-temperature (PTAT) or complementary-to-absolute-temperature (CTAT). For example, in some embodiments: transistor 302 can be formed of 256 fingers in native thick oxide nMOS each with a width of 0.6μ, and a length of 1.2μ; transistor 304 can be formed of eight fingers in thick oxide nMOS each with a width of 0.6μ, and a length of 1.2μ; transistor 306 can be formed of eight fingers in native thick oxide nMOS each with a width of 0.6μ, and a length of 1.2μ; and transistor 308 can be formed of 256 fingers in thick oxide nMOS each with a width of 0.6μ, and a length of 1.2μ.

In some embodiments, similar to what is described above in connection with FIG. 2, a linear expression to temperature (T) based on Vₚ and V_{c} can be determined and used to determine the temperature based on measurements of voltage at Vₚ and V_{c}.

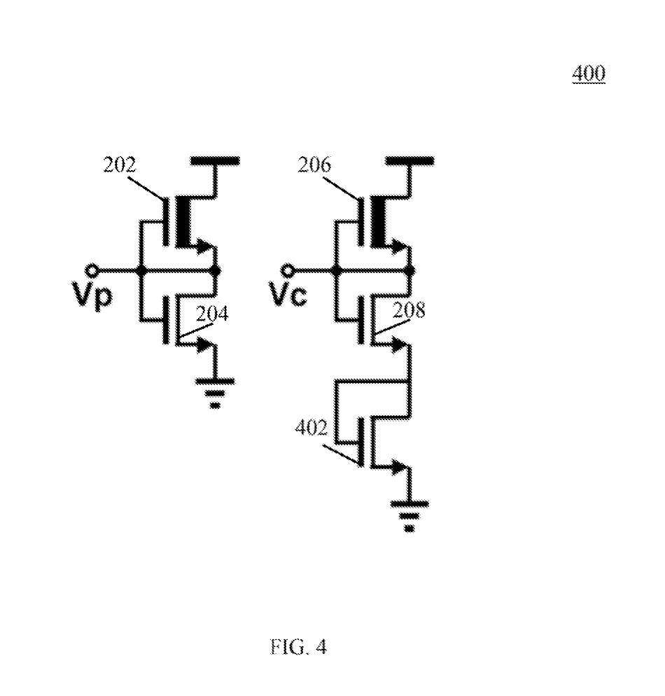

FIG. 4 shows a circuit 400 for temperature monitoring that is similar to circuit 200 illustrated in FIG. 2 except that it adds a diode footer to part of the circuit. In some embodiments, circuit 400 can be created by connecting the source of transistor 208 to a diode footer. For example, in some embodiments a diode footer can be transistor 402 that has a drain connected to its gate and the source of transistor 208 and a source connected to ground.

In some embodiments, transistor 402 can be a high voltage threshold (Vth) nMOS transistor, a high voltage threshold (Vth) pMOS transistor or any other suitable transistor. In some embodiments, transistor 402 can be a diode footer or connected to operate as a diode or any suitable diode device.

In some embodiments, sizing each of transistors 202, 204, 206, 208, and 402 can set the temperature coefficient of output voltages Vₚ, V_{c}, either proportional-to-absolute-temperature (PTAT) or complementary-to-absolute-temperature (CTAT). For example, in some embodiments: transistor 202 can be formed of 52 fingers in native nMOS each with a width of 0.6μ and a length of 0.3μ; transistor 204 can be formed of four fingers in high voltage threshold (Vth) nMOS each with a width of 0.6μ and a length of 0.3μ; transistor 206 can be formed of twenty fingers in native nMOS each with a width of 0.6μ and a length of 0.3μ; transistor 208 can be formed of 76 fingers in high voltage threshold (Vth) nMOS each with a width of 0.6μ and a length of 0.3μ; and transistor 402 can be formed of 800 fingers in high voltage threshold (Vth) nMOS each with a width of 0.6μ and a length of 0.3μ.

In some embodiments, similar to what is described above in connection with FIG. 2, a linear expression to temperature (T) based on Vₚ and V_{c} can be determined and used to determine the temperature based on measurements of voltage at Vₚ and V_{c}.

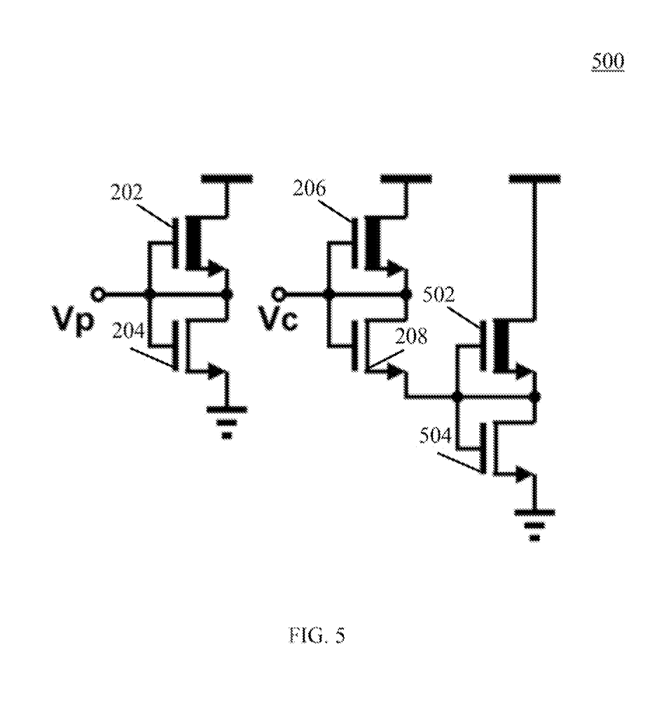

FIG. 5 shows a circuit 500 for temperature monitoring that is similar to circuit 200 illustrated in FIG. 2 except that it adds a two-stack circuit to part of the circuit. In some embodiments, circuit 500 can be created by connecting the source of transistor 208 to a two-stack circuit. For example, in some embodiments a two-stack circuit can be transistors 502 and 504 connected the same way as transistors 202 and 204 are connected as shown in FIG. 2.

Transistors 502 and 504 can be any suitable component(s) or transistors. For example, in some embodiments, transistor 502 can be a native nMOS transistor, a native pMOS transistor or any other suitable transistor. In some embodiments, transistor 504 can be a high voltage threshold (Vth) nMOS transistor, a high voltage threshold (Vth) pMOS transistor or any other suitable transistor.

In some embodiments, sizing each of transistors 202, 204, 206, 208, 502, and 504 can set the temperature coefficient of output voltages Vₚ, V_{c}, either proportional-to-absolute-temperature (PTAT) or complementary-to-absolute-temperature (CTAT). For example, in some embodiments: transistor 202 can be formed of 32 fingers in native nMOS each with a width of 0.6μ and a length of 0.3μ; transistor 204 can be formed of four fingers in high voltage threshold (Vth) nMOS each with a width of 0.6μ and a length of 0.3μ; transistor 206 can be formed of eight fingers in native nMOS each with a width of 0.6μ and a length of 0.3μ; transistor 208 can be formed of 128 fingers in high voltage threshold (Vth) nMOS each with a width of 0.6μ and a length of 0.3μ; transistor 502 can be formed of four fingers in native nMOS each with a width of 0.6μ and a length of 0.3μ; and transistor 504 can be formed of 120 fingers in high voltage threshold (Vth) nMOS each with a width of 0.6μ and a length of 0.3μ.

In some embodiments, similar to what is described above in connection with FIG. 2, a linear expression to temperature (T) based on Vₚ and V_{c} can be determined and used to determine the temperature based on measurements of voltage at Vₚ and V_{c}.

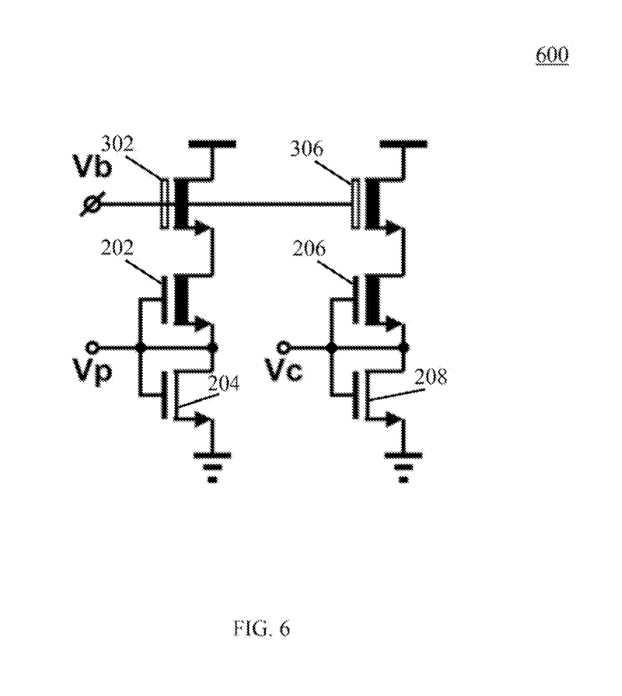

FIG. 6 shows a circuit 600 for temperature monitoring that is similar to circuit 200 illustrated in FIG. 2 except that it adds a cascoding circuit to part of the circuit. In some embodiments circuit 600 can be an area-balanced circuit based on the sizing and type of the transistors and can be created by connecting each of the drains of transistors 202 and 206 to a cascoding circuit. For example, in some embodiments a cascoding circuit can be transistors 302 and 306, which can be similar to the transistors 302 and 306 shown in FIG. 3, with their gates connected to a bias voltage V_{b}, which can be set based on the type of each of transistors 302 and 306, and each of their sources connected to the respective drains of transistors 202 and 206 or any other suitable cascoding circuit.

In some embodiments, sizing each of transistors 302, 306, 202, 204, 206, and 208 can set the temperature coefficient of output voltages Vₚ, V_{c}, either proportional-to-absolute-temperature (PTAT) or complementary-to-absolute-temperature (CTAT). For example, in some embodiments: transistor 302 can be formed of one finger of native thick oxide nMOS with a width of 4μ and a length of 2.5μ; transistor 306 can be formed of one finger of native thick oxide nMOS with a width of 2μ and a length of 2.5μ; transistor 202 can be formed of 40 fingers in native nMOS each with a width of 0.6μ and a length of 0.3μ; transistor 204 can be formed of four fingers in high voltage threshold (Vth) nMOS each with a width of 0.6μ and a length of 0.3μ; transistor 206 can be formed of eight fingers in native nMOS each with a width of 0.6μ and a length of 0.3μ; and transistor 208 can be formed of 132 fingers in high voltage threshold (Vth) nMOS each with a width of 0.6μ and a length of 0.3μ. In another example, in some embodiments: transistor 302 can be formed of one finger of native thick oxide nMOS with a width of 1μ and a length of 2μ; transistor 306 can be formed of one finger of native thick oxide nMOS with a width of 1μ and a length of 2μ; transistor 202 can be formed of sixteen fingers in native nMOS each with a width of 0.6μ and a length of 0.3μ; transistor 204 can be formed of two fingers in high voltage threshold (Vth) nMOS each with a width of 0.6μ and a length of 0.3μ; transistor 206 can be formed of four fingers in native nMOS each with a width of 0.6μ and a length of 0.3μ; and transistor 208 can be formed of 64 fingers in high voltage threshold (Vth) nMOS each with a width of 0.6μ and a length of 0.3μ.

In some embodiments, similar to what is described above in connection with FIG. 2, a linear expression to temperature (T) based on Vₚ and V_{c} can be determined and used to determine the temperature based on measurements of voltage at Vₚ and V_{c}.

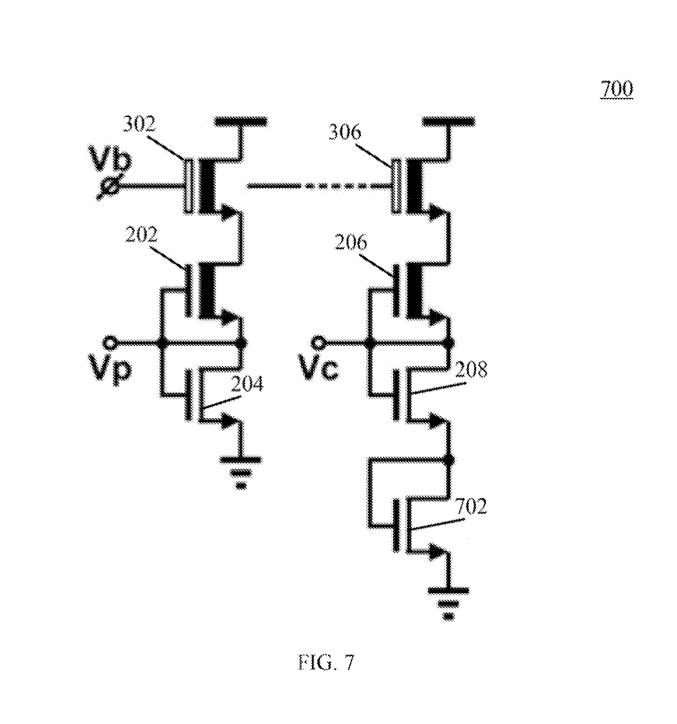

FIG. 7 shows a circuit 700 for temperature monitoring that is similar to circuit 600 illustrated in FIG. 6 except that it adds a diode footer to part of the circuit. In some embodiments, circuit 700 can be an area-balanced circuit and can be created by connecting the source of transistor 208 to a diode footer. For example, in some embodiments a diode footer can be transistor 702 that has a drain connected to its gate and the source of transistor 208 and a source connected to ground.

In some embodiments, transistor 702 can be a high voltage threshold (Vth) nMOS transistor, a high voltage threshold (Vth) pMOS transistor or any other suitable transistor. In some embodiments transistor 702 can be a diode footer or connected to operate as a diode or any suitable diode device.

In some embodiments, sizing each of transistors 302, 306, 202, 204, 206, 208, and 702 can set the temperature coefficient of output voltages Vₚ, V_{c}, either proportional-to-absolute-temperature (PTAT) or complementary-to-absolute-temperature (CTAT). For example, in some embodiments: transistor 302 can be formed of one finger of native thick oxide nMOS with a width of 2μ and a length of 4μ; transistor 306 can be formed of one finger of native thick oxide nMOS with a width of 1μ and a length of 4μ; transistor 202 can be formed of eight fingers in native nMOS each with a width of 0.6μ and a length of 0.3μ; transistor 204 can be formed of one finger in high voltage threshold (Vth) nMOS each with a width of 0.6μ and a length of 0.3μ; transistor 206 can be formed of four fingers in native nMOS each with a width of 0.6μ and a length of 0.3μ; transistor 208 can be formed of 28 fingers in high voltage threshold (Vth) nMOS each with a width of 0.6μ and a length of 0.3μ; and transistor 702 can be formed of 32 fingers in high voltage threshold (Vth) nMOS each with a width of 0.6μ and a length of 0.3μ. In another example, in some embodiments: transistor 302 can be formed of one finger of native thick oxide nMOS with a width of 2μ, and a length of 2μ; transistor 306 can be formed of one finger of native thick oxide nMOS with a width of 1μ and a length of 2μ; transistor 202 can be formed of sixteen fingers in native nMOS each with a width of 0.6μ, and a length of 0.3μ; transistor 204 can be formed of two fingers in high voltage threshold (Vth) nMOS each with a width of 0.6μ, and a length of 0.3μ; transistor 206 can be formed of eight fingers in native nMOS each with a width of 0.6μ, and a length of 0.3μ; transistor 208 can be formed of 64 fingers in high voltage threshold (Vth) nMOS each with a width of 0.6μ, and a length of 0.3μ; and transistor 702 can be formed of 128 fingers in high voltage threshold (Vth) nMOS each with a width of 0.6μ, and a length of 0.3μ.

In some embodiments, similar to what is described above in connection with FIG. 2, a linear expression to temperature (T) based on Vₚ and V_{c} can be determined and used to determine the temperature based on measurements of voltage at Vₚ and V_{c}.

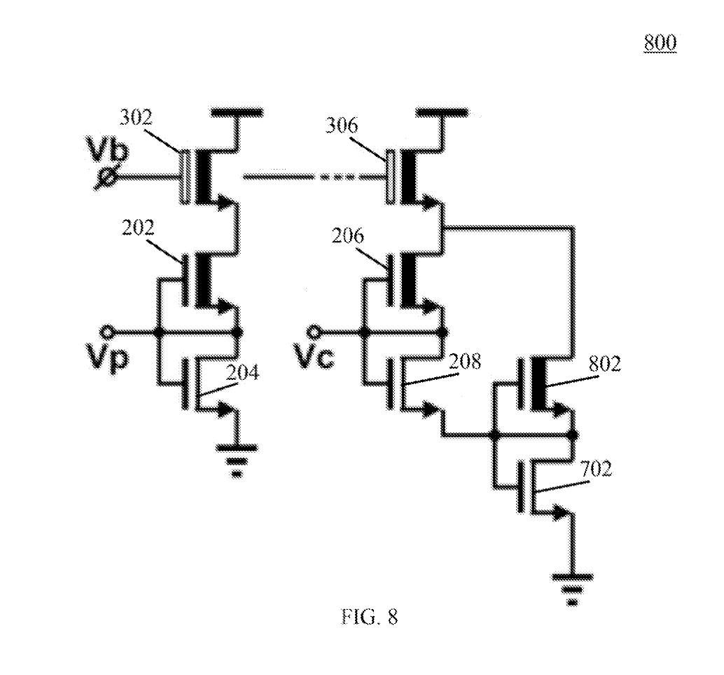

FIG. 8 shows a circuit 800 for temperature monitoring that is similar to circuit 700 illustrated in FIG. 7 except that it adds a two-stack circuit to part of the circuit. In some embodiments, circuit 800 can be and area-balanced circuit and can be created by connecting the source of transistor 208 to a two-stack circuit. For example, in some embodiments a two-stack circuit can be transistors 702 and 802 where the drain of transistor 802 is connected to the source of transistor 306 and the source of transistor 702 is connected to ground.

In some embodiments, transistor 802 can be a native nMOS transistor, a native pMOS transistor or any other suitable transistor.

In some embodiments, sizing each of transistors 302, 306, 202, 204, 206, 208, 802, and 702 can set the temperature coefficient of output voltages Vₚ, V_{c}, either proportional-to-absolute-temperature (PTAT) or complementary-to-absolute-temperature (CTAT). For example, in some embodiments: transistor 302 can be formed of one finger of native thick oxide nMOS with a width of 4μ and a length of 2.5μ; transistor 306 can be formed of one finger of native thick oxide nMOS with a width of 2μ and a length of 2.5μ; transistor 202 can be formed of 32 fingers in native nMOS each with a width of 0.6μ and a length of 0.3μ; transistor 204 can be formed of four fingers in high voltage threshold (Vth) nMOS each with a width of 0.6μ and a length of 0.3μ; transistor 206 can be formed of eight fingers in native nMOS each with a width of 0.6μ and a length of 0.3μ; transistor 208 can be formed of 128 fingers in high voltage threshold (Vth) nMOS each with a width of 0.6μ and a length of 0.3μ; transistor 802 can be formed of four fingers in native nMOS each with a width of 0.6μ and a length of 0.3μ; and transistor 702 can be formed of 32 fingers in high voltage threshold (Vth) nMOS each with a width of 0.6μ and a length of 0.3μ.

In some embodiments, similar to what is described above in connection with FIG. 2, a linear expression to temperature (T) based on Vₚ and V_{c} can be determined and used to determine the temperature based on measurements of voltage at Vₚ and V_{c}.

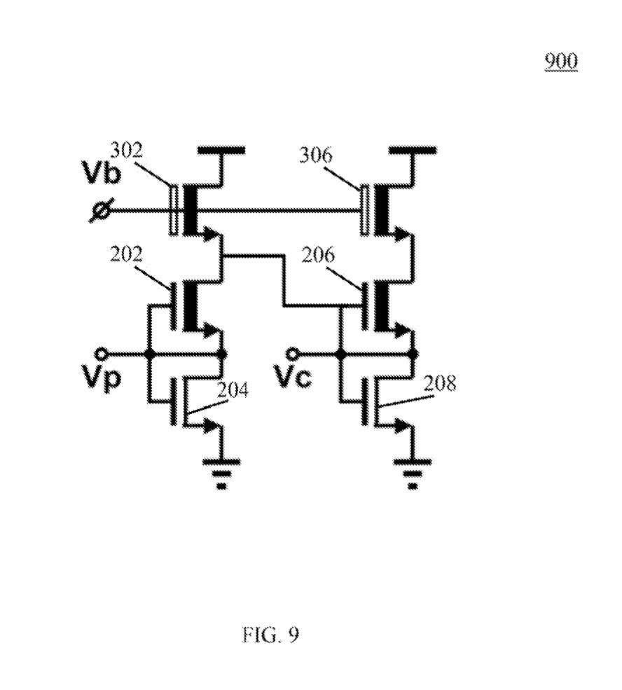

FIG. 9 shows a circuit 900 for temperature monitoring that is similar to circuit 600 illustrated in FIG. 6 except that it adds a connection to part of the circuit. In some embodiments, circuit 900 can be an area-balanced circuit and can be created by connecting the source of transistor 302 to the gate of transistor 206.

In some embodiments, sizing each of transistors 302, 306, 202, 204, 206, and 208 can set the temperature coefficient of output voltages Vₚ, V_{c}, either proportional-to-absolute-temperature (PTAT) or complementary-to-absolute-temperature (CTAT). For example, in some embodiments: transistor 302 can be formed of one finger of native thick oxide nMOS with a width of 4μ and a length of 2μ; transistor 306 can be formed of one finger of native thick oxide nMOS with a width of 1μ and a length of 2μ; transistor 202 can be formed of 32 fingers in native nMOS each with a width of 0.6μ, and a length of 0.3μ; transistor 204 can be formed of two fingers in regular voltage threshold (Vth) nMOS each with a width of 0.6μ, and a length of 0.3μ; transistor 206 can be formed of four fingers in native nMOS each with a width of 0.6μ, and a length of 0.3μ; and transistor 208 can be formed of 32 fingers in regular voltage threshold (Vth) nMOS each with a width of 0.6μ, and a length of 0.3μ.

In some embodiments, similar to what is described above in connection with FIG. 2, a linear expression to temperature (T) based on Vₚ and V_{c} can be determined and used to determine the temperature based on measurements of voltage at Vₚ and V_{c}.

The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Although the invention has been described and illustrated in the foregoing illustrative embodiments, it is understood that the present disclosure has been made only by way of example, and the numerous changes in the details of implementation of the invention can be made without departing from the spirit and scope of the invention, which is only limited by the claims which follow. Features of the disclosed embodiments can be combined and rearranged in various ways.

What is claimed is:

1. A circuit for temperature monitoring, having a first voltage output and a second voltage output, comprising:
a first transistor having a first transistor input, a first transistor output, and a first transistor control, wherein the first transistor input is connected to a supply voltage;
a first diode having a first diode input and a first diode output, wherein the first diode output is connected to ground and the first diode input is connected to the first transistor output, the first transistor control and the first voltage output;
a second transistor having a second transistor input, a second transistor output, and a second transistor control, wherein the second transistor input is connected to a supply voltage; and
a second diode having a second diode input and a second diode output, wherein the second diode input is connected to the second transistor output, the second transistor control, and the second voltage output.

2. The circuit of claim 1, wherein each of the first transistor and the second transistor is a field effect transistor, and wherein the input, the output, and the control of each of the first transistor and the second transistor is a drain, a gate, and a source of the field effect transistor, respectively.

3. The circuit of claim 1, wherein each of the first diode and the second diode is a field effect transistor, and wherein the input and the output of each of the first diode and the second diode is a drain connected to a gate, and a source of the field effect transistor, respectively.

4. The circuit of claim 1, wherein each of the first transistor and the second transistor is a native nMOS transistor and each of the first diode and the second diode is a high voltage threshold (Vth) nMOS transistor.

5. The circuit of claim 1, wherein each of the first transistor and the second transistor is a native pMOS transistor and each of the first diode and the second diode is a high voltage threshold (Vth) pMOS transistor.

6. The circuit of claim 1, wherein the difference between the first voltage output and the second voltage output is proportional-to-absolute-temperature (PTAT).

7. The circuit of claim 1, wherein the difference between the first voltage output and the second voltage output is complementary-to-absolute-temperature (CTAT).

8. The circuit of claim 1, wherein the second diode output is connected to ground.

9. The circuit of claim 1, wherein the second diode output is connected to a diode input of a diode having a diode output connected to ground.

10. A circuit for temperature monitoring, having a first bias input, a first voltage output, and a second voltage output, comprising:
a first transistor having a first transistor input, a first transistor output, and a first transistor control, wherein the first transistor input is connected to a supply voltage and the first transistor control is connected to the first bias input;
a second transistor having a second transistor input, a second transistor output, and a second transistor control, wherein the second transistor input is connected to the first transistor output and the second transistor output and the second transistor control are connected to the first voltage output;
a first diode having a first diode input and a first diode output, wherein the first diode output is connected to ground, and the first diode input is connected to the second transistor output, the second transistor control, and the first voltage output;
a third transistor having a third transistor input, a third transistor output, and a third transistor control, wherein the third transistor input is connected to a supply voltage and the third transistor control is connected to the first bias input;
a fourth transistor having a fourth transistor input, a fourth transistor output, and a fourth transistor control, wherein the fourth transistor input is connected to the third transistor output and the fourth transistor output and the fourth transistor control are connected to the second voltage output; and
a second diode having a second diode input and a second diode output, wherein the second diode input is connected to the fourth transistor output and the second voltage output.

11. The circuit of claim 10, wherein each of the first transistor, the second transistor, the third transistor, and the fourth transistor is a field effect transistor, and wherein the input, the output, and the control of each of the first transistor, the second transistor, the third transistor, and the fourth transistor is a drain, a gate, and a source of the field effect transistor, respectively.

12. The circuit of claim 10, wherein each of the first transistor, the second transistor, the third transistor, and the fourth transistor is a native nMOS transistor and each of the first diode and the second diode is a high voltage threshold (Vth) nMOS transistor.

13. The circuit of claim 10, wherein the first transistor, the second transistor, the third transistor, and the fourth transistor is a native pMOS transistor and each of the first diode and the second diode is a high voltage threshold (Vth) pMOS transistor.

14. The circuit of claim 10, wherein the difference between the first voltage output and the second voltage output is proportional-to-absolute-temperature (PTAT).

15. The circuit of claim 10, wherein the difference between the first voltage output and the second voltage output is complementary-to-absolute-temperature (CTAT).

16. The circuit of claim 10, wherein the second diode output is connected to ground.

17. The circuit of claim 10, wherein the second diode output is connected to a diode input of a diode having a diode output connected to ground.

18. A circuit for temperature monitoring, having a first bias input, a first voltage output, and a second voltage output, comprising:
a first transistor having a first transistor input, a first transistor output, and a first transistor control, wherein the first transistor input is connected to a supply voltage and the first transistor control is connected to the first bias input;
a second transistor having a second transistor input, a second transistor output, and a second transistor control, wherein the second transistor input is connected to the first transistor output and the second transistor output and the second transistor control are connected to the first voltage output;
a first diode having a first diode input and a first diode output, wherein the first diode output is connected to ground, and the first diode input is connected to the second transistor output, the second transistor control, and the first voltage output;
a third transistor having a third transistor input, a third transistor output, and a third transistor control, wherein the third transistor input is connected to a supply voltage and the third transistor control is connected to the first bias input;
a fourth transistor having a fourth transistor input, a fourth transistor output, and a fourth transistor control, wherein the fourth transistor input is connected to the third transistor output and the fourth transistor output and the fourth transistor control are connected to the second voltage output and the first transistor output; and
a second diode having a second diode input and a second diode output, wherein the second diode input is connected to the fourth transistor output, the fourth transistor control, and the second voltage output.

19. The circuit of claim 18, wherein each of the first transistor, the second transistor, the third transistor, and the fourth transistor is a field effect transistor, and wherein the input, the output, and the control of each of the first transistor, the second transistor, the third transistor, and the fourth transistor is a drain, a gate, and a source of the field effect transistor, respectively.

20. The circuit of claim 18, wherein each of the first diode and the second diode is a field effect transistor, and wherein the input and the output of each of the first diode and the second diode is a drain connected to a gate, and a source of the field effect transistor, respectively.

21. The circuit of claim 18, wherein each of the first transistor, the second transistor, the third transistor, and fourth transistor is a native nMOS transistor and each of the first diode and the second diode is a high voltage threshold (Vth) nMOS transistor.

22. The circuit of claim 18, wherein each of the first transistor, the second transistor, the third transistor, and the fourth transistor is a native pMOS transistor and each of the first diode and the second diode is a high voltage threshold (Vth) pMOS transistor.

23. The circuit of claim 18, wherein the difference between the first voltage output and the second voltage output is proportional-to-absolute-temperature (PTAT).

24. The circuit of claim 18, wherein the difference between the first voltage output and the second voltage output is complementary-to-absolute-temperature (CTAT).

25. The circuit of claim 18, wherein the second diode output is connected to ground.

26. The circuit of claim 18, wherein the second diode output is connected to a diode input of a diode having a diode output connected to ground.
